(19) United States
(12) Patent Application Publication
(10) Pub. No.: US 2009/0016660 A1
(43) Pub. Date: Jan. 15, 2009

(54) SOLID LUBRICATION ROLLER BEARING

(75) Inventors: Kenji Sunahara, Kitakyushu-shi (JP); Michiaki Ikeda, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi, Fukuoka (JP)

(21) Appl. No.: 11/908,829

(22) PCT Filed: Mar. 3, 2006
(86) PCT No.: PCT/JP2006/304112

§ 371 Date: Sep. 17, 2007

(30) Foreign Application Priority Data
Mar. 17, 2005 (JP) 2005-076998

(51) Int. Cl. F16C 33/66

(52) U.S. Cl. 384/463

(57) ABSTRACT

A solid lubrication roller bearing capable of stably transferring a lubricant from spacers and reducing wear of a solid lubrication film on the surfaces of rollers is provided. The solid lubrication roller bearing comprises a raceway member having two rolling surfaces, a plurality of rollers forming first members disposed between the rolling surfaces to carry a load and covered with a solid lubrication film, and spacers forming second members interposed between the rollers to hold intervals formed of a self-lubricating material and having a recessed surface in contact with the rollers. Metal balls with a hardness higher than that of the spacer forming third members with a diameter smaller than that of the rollers are interposed between the spacers in at least one position.

### FIELD OF THE INVENTION

The present invention relates to a solid lubrication roller bearing used in special environments such as, e.g., vacuum environments, high temperature environments, low temperature environments, or radiation environments, in which lubricating oil or grease cannot be used.

### TECHNICAL BACKGROUND

Conventional solid lubrication roller bearings used in special environments such as e.g., vacuum environments, high temperature environments, low temperature environments, or radiation environments, in which lubricating oil or grease cannot be used, are shown in FIGS. 3 and 4.

FIG. 3 is a side development view showing a first conventional solid lubrication roller bearing.

In FIG. 3, the reference numeral 1 denotes an inner ring, 2 denotes an outer ring, 5 denotes a recessed spacer (second member), 6 and 6A denote rollers (first members). As shown in FIG. 3, in a cross roller bearing which is one type of roller bearing in which adjacent rollers 6 and 6A are disposed between two raceway members, or the inner ring 1 and the outer ring 2, in a crossed manner with the direction changed by 90 degrees, it is proposed to constitute such that the surface of the roller 6 and 6A is covered with a solid lubrication film 7 and both the right and left side surfaces of the spacer 5 are recessed so as to rotatably fit adjacent rollers 6 and 6A (see, e.g., Patent Document 1).

FIG. 4 is a side development view showing a second conventional solid lubrication roller bearing.

In this second conventional design, such construction is proposed that no solid lubrication film is provided on the surface of the roller and that the spacer 5A as a second member, is made of resin and formed into a spherical shape (see, e.g., Patent Document 2).

In the aforementioned conventional designs, it is expected that the solid lubrication film on the roller surface is lubricated at the initial operation stage and the lubrication ingredients, from the spacers 5 and 5A made of a self-lubricating material, are transferred to rollers 6 and 6A in the course of operation and then to the inner and outer rings to thereby attain long-term lubrication.

Patent Document 1: Japanese Unexamined Laid-open Patent Publication H10-141363, A.

Patent Document 2: Japanese Unexamined Laid-open Utility Model Publication H02-74625, A.

### DISCLOSURE OF THE INVENTION

### Problems to be Solved by the Invention

In the first conventional design, however, since the spacer is formed to have a recessed surface which fits the cylindrical surface of the roller, the spacer comes into surface-contact with the rollers, resulting in a low surface pressure. This causes a problem that almost no transferring of lubricating agent occurs.

Furthermore, in the second conventional design, since no solid lubrication film is provided on the surface of the roller, initial lubrication cannot be performed, resulting in a short lifespan. If a solid lubrication film is formed on the surface of the roller, the lubricant transfer amount becomes large due to the point contact because the spacer is formed into a convex shape (sphere) so as not to fit the cylindrical surface of the roller. However, because of the point contact of the contact portion, the solid lubrication film wears quickly at the contact point portion, resulting in a short lifespan.

The present invention was made in view of the aforementioned problems, and aims to provide a solid lubrication ball bearing capable of stably transferring a lubricant from spacers and reducing wear of solid lubrication films formed on surfaces of rollers.

### Means to Solve the Problems

In order to solve the aforementioned problems, the present invention is constituted as follows.

According to the invention as recited in claim 1, a solid lubrication roller bearing comprises a raceway member having two rolling surfaces, a plurality of rollers forming first members disposed between the rolling surfaces to carry a load and covered with a solid lubrication film, and spacers forming second members interposed between the rollers to hold intervals formed of a self-lubricating material and having a recessed surface in contact with the roller, wherein

metal balls with a hardness higher than that of the spacers forming third members with a diameter smaller than that of the roller are interposed between the spacers in at least one position.

According to the invention as recited in claim 2, a ratio of the number of the balls to the number of the rollers when the number of balls is 0 (zero) is 13% or more but not larger than 50%.

According to the invention as recited in claim 3, a surface of the ball is covered with a molybdenum disulfide film.

### Effects of the Invention

According to the present invention, the following effects can be attained.

(1) According to the invention as recited in claim 1, the ball forming the third member interposed between the spacers is in contact with the spacers, and the lubricating agent of the spacers is transferred to the ball and then to the inner and outer rings, which enables long-term operation of the solid lubrication roller bearing. Furthermore, since there exists no member in point-contact with the solid lubrication film on the roller surface, no early-wear phenomenon of the solid lubrication film occurs.

(2) According to the invention as recited in claim 2, the ratio of the number of balls to the number of rollers in cases where no ball is used, is set to 13% or more. Thus, the amount of lubricant agent transferred from the spacers becomes sufficient. Furthermore, the ratio is set to be no larger than 50%. Thus, deterioration of load capacity due to the decreased number of rollers can be restrained. In other words, when the ratio is 13% or more but not larger than 50%, the lifespan can be balanced at the highest level.

(3) According to the invention as recited in claim 3, the molybdenum disulfide coated on the surface of the ball forming the third member can be transferred to the inner and outer rings as an excellent lubricating agent.

The aforementioned effects can attain a longer lifespan of the solid lubrication roller bearing.

### BRIEF DESCRIPTION OF THE DRAWINGS

FIG. 1 shows an embodiment of the present invention, wherein FIG. 1(a) is a side development view of a roller bearing, and FIG. 1(b) is an enlarged cross-sectional view taken along the line A-A in FIG. 1(a);

FIG. 2 is a graph showing effects of the present invention;

FIG. 3 is a side development view of a roller bearing according to a first conventional design; and

FIG. 4 is a side development view of a roller bearing according to a second conventional design.

### BRIEF DESCRIPTION OF REFERENCE NUMERALS

1 Inner ring
2 Outer ring
3 Inner rolling surface
4 Outer rolling surface
5, 5A Spacer (second member)
6, 6A Roller (first member)
7, 7A Solid lubrication film
8 Ball (third member)

### BEST MODE FOR CARRYING OUT THE INVENTION

Hereinafter, embodiments of the present invention will be explained with reference to drawings.

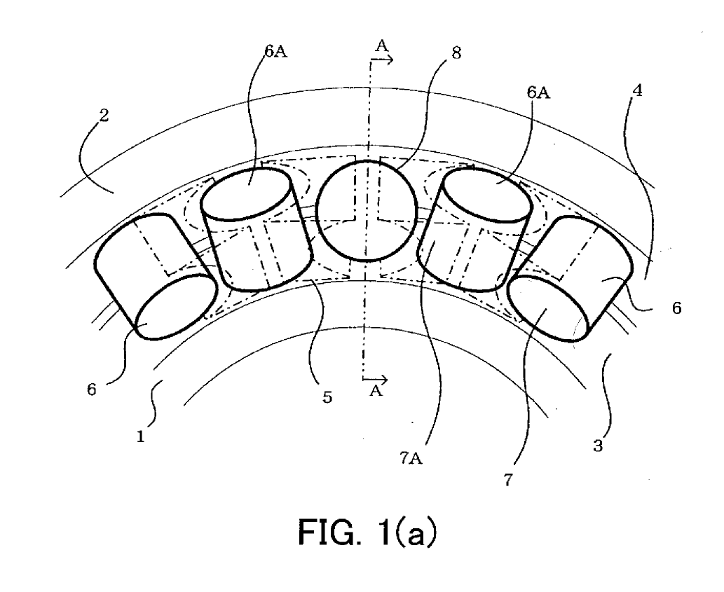

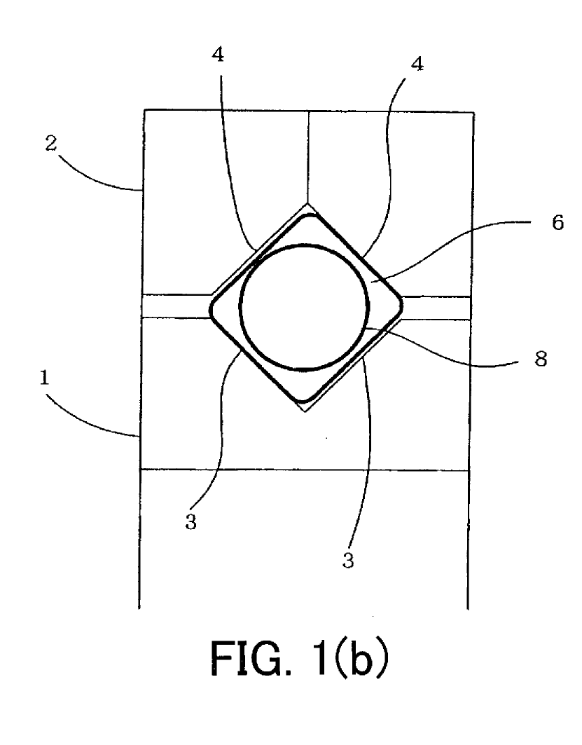

FIG. 1 shows an embodiment of the present invention, wherein FIG. 1(a) is a side development view of a roller bearing, and FIG. 1(b) is an enlarged cross-sectional view taken along the line A-A in FIG. 1(a).

In FIGS. 1(a) and 1(b), the reference numeral 1 denotes an inner ring, 2 denotes a halved outer ring, 3 denotes a 90° V-shaped inner ring rolling surface formed on the outer peripheral surface of the inner ring 1, 4 denotes an outer ring rolling surface with the same shape formed on the inner peripheral surface of the outer ring 2 so as to face the inner ring rolling surface 3, 6 denotes a roller forming a first member disposed between the rolling surfaces 3 and 4 and made of SUS440C. The rollers are disposed as roller 6 and roller 6A alternatively changed in direction. On the surface of roller 6 and 6A, a molybdenum disulfide film 1 μm in thickness is coated as solid lubricating agent.

5 denotes a spacer forming a second member disposed between roller 6 and roller 6A. 7 denotes a ball forming a second member. The diameter of the ball is set to be smaller than the diameter of the roller by about 30 μm.

The present invention is different from conventional designs, especially the design disclosed by the aforementioned Patent Document 1 in that metal balls 7 with a hardness higher than that of spacers 5 forming third members with a diameter smaller than that of the roller are interposed between spacers 5 in at least one position.

Hereinafter, the operation will be explained.

Since the rollers 6 and 6A are in face-contact with spacer 5, almost no lubricating agent transfer occurs. Due to the face-contact, no abnormal wear of the solid lubrication film on the surface of roller 6 and 6A occurs. The transfer of the lubricating agent occurs by the sliding contact between ball 8 and spacers 5. Since ball 8 is in point-contact with spacers 5, the lubricating agent of spacers 5 will be transferred to ball 8 and then to the inner and outer rings 1 and 2. This mechanism enables long-term lubrication.

Generally, if some rollers are replaced with balls having a smaller diameter, the number of rollers carrying a load decreases, resulting in an increased load to be carried by the remaining rollers, which in turn shortens their lifespan. Accordingly, as a lifespan extension measure, it is not usually considered to employ such a bearing structure.

As a result of various experiments however, it was found that the combination of a spacer made of a self-lubricating material and a ball with a hardness higher than that of the spacer can attain a lifespan extending effect which far exceeds compensation of the lifespan deterioration. This is because the pin-point contact sliding of the ball with respect to the spacers, substantially increases the transfer of the lubricating agent, which hardly occurs by a line contact of the combination of spacers and a roller.

The embodiment of the present invention is directed to the so-called cross roller bearing in which adjacent rollers are disposed orthogonally. However, since the function of the present invention is to improve the transfer of the lubrication agent from spacers in a solid lubrication roller bearing, the same effects can be attained in various bearings other than cross roller bearings such as, e.g., radial roller bearings, thrust roller bearings, or tapered roller bearings. Furthermore, the same effects can also be attained in direct acting type bearings other than rotating type bearings.

### EXAMPLE 1

Hereinafter, an example according to an embodiment of the present invention will be explained.

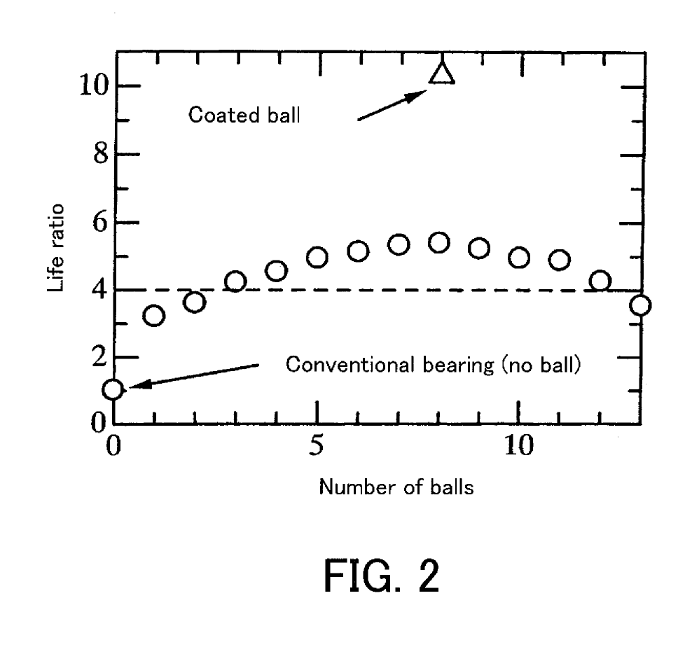

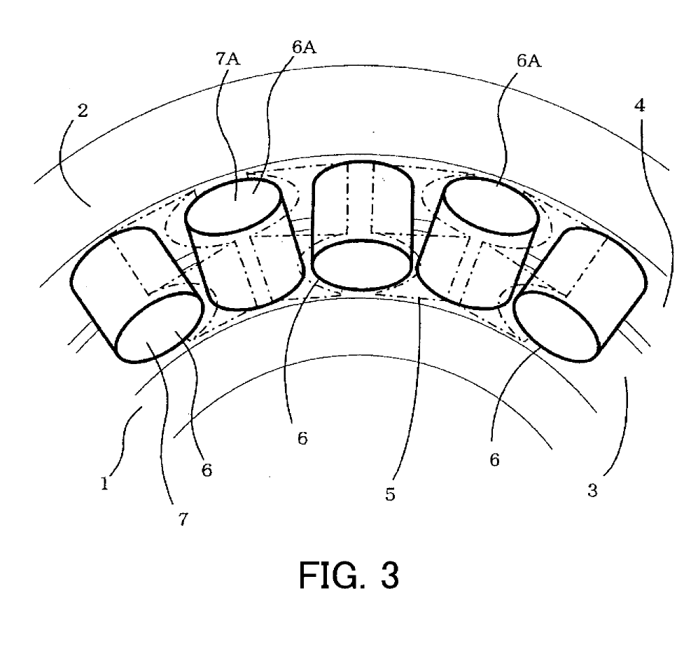

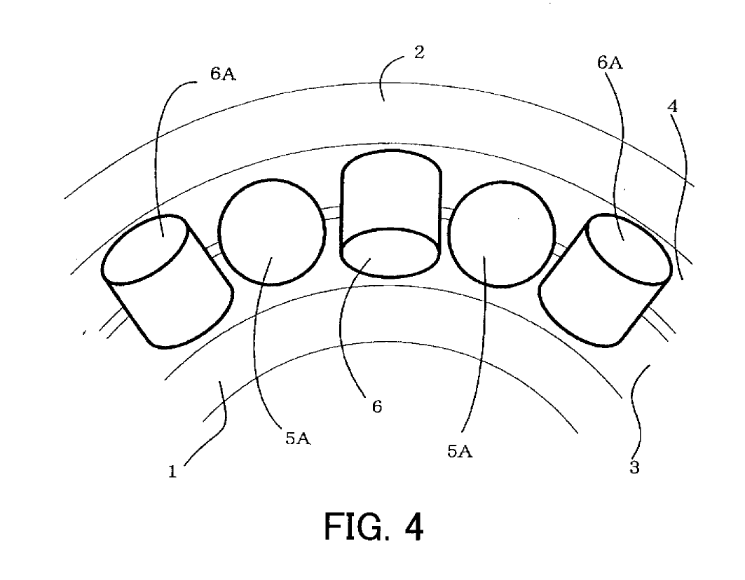

In this example, rollers 6 and 6A having a diameter of 4.00 mm and a length of 3.85 mm, bearing balls 8 made of SUS440C having a diameter of 3.97 mm, and spacers 5 made of a self-lubricating resin containing PEEK as a main ingredient were used. In order to confirm the lifespan extension effect by interposing balls 8 forming third members, 24 pieces of rollers 6 and 6A were initially interposed. Then, the lifespan extension effect when n pieces of the rollers were replaced with balls 8 forming the third members was investigated by increasing the number of balls by n=1. In evaluating the bearing lifespan, using a lifespan testing machine in which an axial load of 215 N was loaded to two bearings and a motor was rotated at 320 r/min, a bearing having an inner diameter of 30 mm, an outer diameter of 55 mm, and a width of 10 mm was evaluated. The torque output of the motor was monitored during the test, and the time when the torque exceeded twice the normal torque was considered to be the bearing lifespan. In FIG. 2, as the effect of the present invention, the lifespan of solid lubrication roller bearings different in number of balls 8 are shown as a lifespan ratio with respect to the case in which the lifespan of a conventional design (the number of ball is 0) is defined as 1. It reveals that the lifespan ratio increases more than three times when one or more balls 8 are used. The reason is that the transfer of lubricating agent which did not occur because of the low surface pressure between rollers 6 and 6A and spacers 5 occurred between ball 8 and spacers 5 by interposing the ball 8.

### EXAMPLE 2

The lifespan when the number of balls 8 is set to 3 to 12 increased four times or more as compared with the lifespan of a conventional design. If the number of balls 8 is set to 13 or more, the lifespan starts to decrease. The reason is that the number of rollers 6 and 6A, i.e. the load capacity, decreases as the number of balls 8 increases. By the balance between the increase of the lubricating agent transferred amount and the decrease of the load capacity, the lifespan ratio increases four times or more when the number of balls 8 is 3 to 12, resulting in long lifespan.

Since the number of rollers 6 and 6A in the prior design is 24, the ratio to the number of rollers of the conventional design (number of balls/number of rollers of the conventional example) is 3/24=12.5% when the number of balls is 3, and 12/24=50% when the number of balls is 12. In other words, it can be said that long lifespan four times or more as compared with a conventional bearing can be attained when the number of balls/the number of rollers of the conventional design is 13% or more, but not larger than 50%.

Next, the same test was performed by coating the surface of the ball with a molybdenum disulfide film 1 μm in thickness. The number of balls was 8. As shown in FIG. 2 with the plot Δ, the lifespan ratio increased 10 times or more. This is because the molybdenum disulfide on the ball surface was transferred to the inner and outer rings as an excellent lubricating agent.

As mentioned above, since some of the plurality of rollers are replaced with balls, the lubricating agent ingredient of the spacers is transferred from the point-contact portion between the ball and the spacers, to the ball and then to the inner and outer rings, which extends the lifespan. As a result, a solid lubrication roller bearing having long lifespan can be provided.

### INDUSTRIAL APPLICABILITY

The present invention can be applied in a field for providing a solid lubrication roller bearing capable of stably transferring a lubricating agent from a spacer and decreasing the wear of a solid lubrication film on a roller surface by applying to a solid lubrication roller bearing used special environments such as, e.g., vacuum environments, high temperature environments, low temperature environments, or radiation environments, in which lubricating oil or grease cannot be used.

What is claimed is:

1. A solid lubrication roller bearing comprising: a raceway member having two rolling surfaces, a plurality of rollers forming first members disposed between the rolling surfaces to carry a load and covered with a solid lubrication film, and spacers forming second members interposed between the rollers to hold intervals formed of a self-lubricating material and having a recessed surface in contact with the roller, wherein
metal balls with a hardness higher than that of the spacers forming third members with a diameter smaller than that of the roller are interposed between the spacers in at least one position.

2. The solid lubrication roller bearing as recited in claim 1, wherein a ratio of the number of the balls to the number of the rollers in cases where no ball is used is 13% or more but not larger than 50%.

3. The solid lubrication roller bearing as recited in claim 1, wherein a surface of the ball is covered with a molybdenum disulfide film.
